(19) United States
(12) Patent Application Publication
(10) Pub. No.: US 2022/0117194 A1
(43) Pub. Date: Apr. 21, 2022

(54) AUTOMATIC FEEDING DEVICE FOR ANIMALS

(71) Applicant: Junzhou Huang, Shenzhen (CN)

(72) Inventor: Junzhou Huang, Shenzhen (CN)

(21) Appl. No.: 17/565,488

(22) Filed: Dec. 30, 2021

Related U.S. Application Data
(63) Continuation-in-part of application No. PCT/CN2020/105858, filed on Jul. 30, 2020.

(30) Foreign Application Priority Data
Aug. 22, 2019 (CN) 201921372386.3

(51) Int. Cl. A01K 5/02

(52) U.S. Cl. CPC A01K 5/0275

(57) ABSTRACT

The present application relates to an automatic feeding device for animals, comprising a food storage container, a food supply container, a feeding container, a quantitative supply mechanism, a driving mechanism, and a controller. The food storage container has a material inlet and a material outlet; the food supply container has a food supply inlet and a food supply outlet, and the food supply inlet is in butt joint with the material outlet; the quantitative supply mechanism is provided between the food supply inlet and the food supply outlet; the driving mechanism is provided below the quantitative supply mechanism; the feeding container is provided outside the food supply container below the food supply outlet; the controller sends a control signal which controls the driving mechanism to drive the quantitative supply mechanism to quantitatively export food which then falls into the feeding container. The automatic feeding device for animals achieves quantitative feeding.

### CROSS-REFERENCE TO RELATED APPLICATIONS

The present application is a continuation-in-part application based on a PCT application No. PCT/CN2020/105858 filed on Jul. 30, 2020, which claims the benefit of Chinese Patent Application No. 201921372386.3 filed on Aug. 22, 2019. All the above are hereby incorporated by reference.

### FIELD

The present application relates to animal feeding articles, and in particular, to an automatic feeding device for animals.

### BACKGROUND

With the development of social economy, people's quality of life is getting higher and higher, and more and more people keep pets. The raising of domestic pets such as pet dogs and pet cats has also become an important pastime in people's lives. A very important task during pet raising is feeding food. For the health of pets, the amount of food fed each time needs to be as regular and quantitative as possible. However, at present, people generally use artificial feeding, which requires a lot of time and energy for the owner to feed each day, and it is difficult to control the feeding time and amount, which is not conducive to the health of the pet. If the owner is out, he/she cannot feed the pet in time.

### SUMMARY

The technical problem to be solved by the present application is to provide an automatic feeding device for animals in response to the above-mentioned defects of the prior art.

According to an aspect of the present application, an automatic feeding device for animals is provided, comprising a food storage container, a food supply container, a feeding container, a quantitative supply mechanism, a driving mechanism and a controller, wherein the food storage container has a material inlet and a material outlet, the food supply container has a food supply inlet and a food supply outlet, and the food supply inlet of the food supply container is in butt joint with the material outlet of the food storage container, the quantitative supply mechanism is arranged between the food supply inlet and the food supply outlet in the food supply container, the driving mechanism is arranged below the quantitative supply mechanism in the food supply container, the feeding container is arranged outside the food supply container below the food supply outlet, and the controller sends a control signal to the driving mechanism which controls the driving mechanism to drive the quantitative supply mechanism to quantitatively export food entering the food supply container from the food storage container to the food supply outlet, from which the food falls into the feeding container.

In one embodiment of the present application, the food storage container comprises a food storage cover and a food storage barrel, and a top of the food storage barrel is open to form a material inlet, a bottom of the food storage barrel is open to form a material outlet, and the food storage cover is closed on the top of the food storage barrel to close the material inlet, and detachable positioning and inserting structures are provided at the bottom of the food storage barrel along its circumferential direction that cooperates with a top of the food supply container.

In one embodiment of the present application, a rear side of the food storage cover is pivotally connected to the food storage barrel, and a front side of the food storage cover is provided with a downwardly extending elastic button which cooperates with a corresponding hole on a front side of the food storage barrel to realize a detachable buckling connection.

In one embodiment of the present application, a rear side of the food storage cover is pivotally connected to the food storage barrel, and a slot is provided on inner wall of the front side of the food storage barrel at the material inlet, and a movable elastic latch at a corresponding position on the top of the food storage cover is inserted into the slot so that the food storage cover is closed on the food storage barrel.

In one embodiment of the present application, a transparent or translucent decorative part is further provided on the front side of the food storage cover or the food storage barrel.

In one embodiment of the present application, the food storage container comprises a food storage cover and a food storage barrel, and the food storage barrel is accommodated in the food supply container above the quantitative supply mechanism, a material outlet at the bottom of the food storage barrel serves as a food supply inlet of the food supply container to be directly in butt joint with the quantitative supply mechanism, the food storage cover is closed on the top of the food supply container, and a rear side of the food storage cover is pivotally connected with the food supply container, and a front side of the food storage cover is detachably buckled with the food supply container.

In one embodiment of the present application, the food storage cover comprises a cover body and a control box installed at the bottom of the cover body, and a rear side of the cover body is pivotally connected to the food supply container, a front side of the cover body is detachably buckled with the food supply container, and the control box is provided with a first wire groove extending backward to a pivoting position of the cover body and the food supply container and docked with a second wire groove vertically arranged in the food supply container; the controller is installed and fixed in the control box, and wires of the controller are led out from the control box, and then enter from the first wire groove through the pivoting position of the food storage cover and the food supply container into the second wire groove, thus are electrically connected with the driving mechanism.

In one embodiment of the present application, a transparent or translucent observation window is provided on a side wall of the food supply container.

In one embodiment of the present application, the quantitative supply mechanism comprises a supply bowl, a supply shaft, a supply wheel and a plurality of supply plates, and the supply bowl is fixed in the food supply container below the food supply inlet, the supply shaft is vertically installed in the center of the supply bowl and passes through the bottom of the supply bowl, the supply wheel is fixed on the supply shaft in the supply bowl, and the plurality of supply plates are installed on the supply wheel at intervals around its circumference to rotate in the supply bowl along with the supply shaft, and a quantitative feeding space is formed between every two adjacent supply plates, and a through cut is formed on the side of the supply bowl close to the food supply outlet to be in butt joint with the food supply outlet.

In one embodiment of the present application, an inclined guide plate is positioned over the quantitative supply mechanism in the food supply container at the side facing the through cut, and the guide plate guides food to the side of the supply bowl away from the through cut.

In one embodiment of the present application, a supply comb is fixed in the supply bowl above the supply plates and the supply comb is located directly facing a lower end of the guide plate.

In one embodiment of the present application, the food supply outlet is obliquely arranged below the through cut of the supply bowl, and a lower end of the food supply outlet is supported on corresponding supporting steps provided in the food supply container, and an upper end of the food supply outlet is installed at the bottom of the supply bowl.

In one embodiment of the present application, the driving mechanism comprises a driving motor, a first transmission belt, a first transmission wheel, a second transmission wheel, a second transmission belt, a third transmission wheel, a worm and gear plate; the driving motor is electrically connected to the controller, and an output end of the driving motor drives the first transmission wheel to rotate through the first transmission belt, thereby driving the second transmission wheel coaxial with the first transmission wheel to rotate, and then driving the third transmission wheel to rotate by the second transmission belt, thereby driving the worm coaxial with the second transmission wheel to rotate, thereby driving the gear plate meshed with the worm to rotate; and the gear plate is provided with a coupling structure that is coaxially connected with the supply shaft.

In one embodiment of the present application, the driving mechanism further comprises a sensory switch which monitors a rotation angle of the gear plate and feeds it back to the controller.

In one embodiment of the present application, a base below the food supply outlet of the food supply container is concavely formed with a notch, and the feeding container is installed in the notch through a limiting structure.

In one embodiment of the present application, the quantitative supply mechanism comprises a supply bowl, a supply shaft, a supply wheel and at least two supply blocks, and the supply bowl is fixed in the food supply container below the food supply inlet, the supply shaft is installed in the center of the supply bowl and passes through the bottom of the supply bowl, the supply wheel is fixed on the supply shaft in the supply bowl, and the at least two supply blocks are installed on the supply wheel at intervals around its circumference to rotate in the supply bowl along with the supply shaft, and a quantitative feeding space is formed between every two adjacent supply plates, and a through cut is formed on the side of the supply bowl close to the food supply outlet to be in butt joint with the food supply outlet, and the at least two supply blocks have a shape that can cover the through cut.

In one embodiment of the present application, the driving mechanism comprises a driving motor, a worm, a transmission gear set and an output gear; the driving motor is electrically connected to the controller, and an output end of the driving motor drives the transmission gear set to rotate through the worm, thereby driving the output gear to rotate through the transmission gear set; and the output gear is provided with a coupling structure that is coaxially connected with a supply shaft of the quantitative supply mechanism.

In one embodiment of the present application, the quantitative supply mechanism and the driving mechanism are installed in the food supply container obliquely with respect to a horizontal direction.

Implementing the automatic feeding device for animals according to the present application has the following beneficial effects: food can be added into the automatic feeding device for animals according to the embodiments of the present application by opening the food storage cover, and then the food falls into the food supply container through the material outlet and then falls into a quantitative supply space between the two adjacent supply plates in the supply bowl of the quantitative supply mechanism, and then the controller controls the driving motor to run according to the user's setting, and the driving motor drives the supply shaft to rotate a certain angle to export the food in the quantitative supply space to the food supply outlet, and then the food falls into the feeding container for animals to enjoy. In this way, the automatic feeding device for animals can realize regular and quantitative feeding according to the user's setting, which is convenient for the user and beneficial to the health of the pet.

### BRIEF DESCRIPTION OF THE DRAWINGS

The present application will be further described below in conjunction with the accompanying drawings and embodiments. In the accompanying drawings:

FIG. 1 is a schematic overall structural diagram of an automatic feeding device for animals according to a first embodiment of the present application;

FIG. 2 is a partially exploded structural diagram of the automatic feeding device for animals as shown in FIG. 1;

FIG. 3 is a top structural diagram of a food supply container in the automatic feeding device for animals as shown in FIG. 1;

FIG. 4 is an internal structural diagram of the food supply container as shown in FIG. 3;

FIG. 5 is a structural diagram of a quantitative supply mechanism as shown in FIG. 4;

FIG. 6 is a structural diagram of a base and a driving mechanism as shown FIG. 4;

FIG. 7 is a structural diagram of a feeding container in the automatic feeding device for animals as shown in FIG. 1;

FIG. 8 is a schematic overall structural diagram of an automatic feeding device for animals according to a second embodiment of the present application;

FIG. 9 is an exploded structural diagram of a food storage container in the automatic feeding device for animals as shown in FIG. 8;

FIG. 10 is a schematic overall structural diagram of an automatic feeding device for animals according to a third embodiment of the present application;

FIG. 11 is a top structural diagram of the automatic feeding device for animals as shown in FIG. 10 with a food storage cover being removed;

FIG. 12 is an internal structural diagram of a food supply container of the automatic feeding device for animals as shown in FIG. 10 with an outer shell being removed;

FIG. 13 is a schematic overall structural diagram of an automatic feeding device for animals according to a fourth embodiment of the present application;

FIG. 14 is a schematic structural diagram of a base and a driving mechanism according to a fifth embodiment of the present application;

FIG. 15 is a schematic diagram of top structure of a food supply container according to a sixth embodiment of the present application;

FIG. 16 is a schematic diagram of bottom structure of the food supply container as shown in FIG. 15;

FIG. 17 is a schematic structural diagram of a quantitative supply mechanism according to a seventh embodiment of the present application;

FIG. 18 is a schematic diagram of bottom structure of the quantitative supply mechanism as shown in FIG. 17.

### DETAILED DESCRIPTION

In order to make the purpose, technical solutions, and advantages of the present application clearer, the following further describes the present application in detail with reference to the accompanying drawings and embodiments. It should be understood that the specific embodiments described here are only used to explain the present application, and are not used to limit the present application.

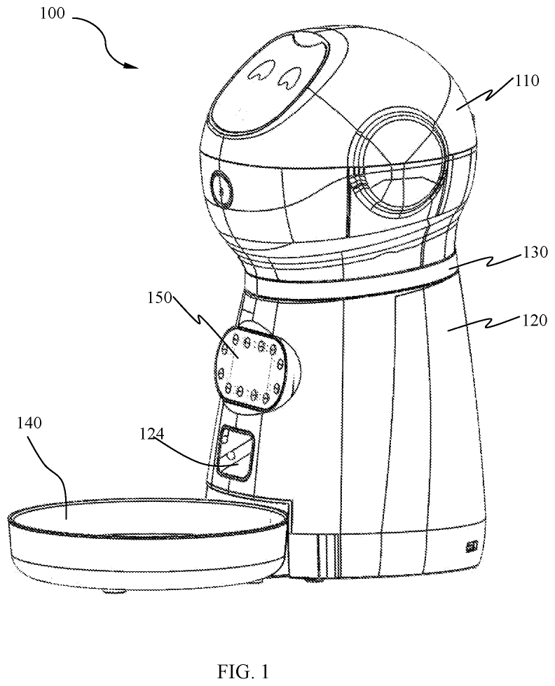

FIGS. 1 to 7 show a specific structure of an automatic feeding device for animals 100 according to a first embodiment of the present application. Referring to FIGS. 1 to 7, the automatic feeding device for animals 100 according to the first embodiment of the present application comprises a food storage container 110, a food supply container 120, a feeding container 140, a quantitative supply mechanism 160, a driving mechanism 170, and a controller 150. The food storage container 110 has a material inlet 113 and a material outlet 114, and is used for holding food for feeding animals, such as granular dog food, cat food, and the like. The food supply container 120 has a food supply inlet 123 and a food supply outlet 124. The food supply inlet 123 is in butt joint with the material outlet 114 of the food storage container 110. The quantitative supply mechanism 160 is provided between the food supply inlet 123 and the food supply outlet 124 in the food supply container 120, and is used to quantitatively guide the food which enters the food supply inlet 123 of the food supply container 120 from the food storage container 110 to the food supply outlet 124. Then the food falls by its own gravity from the food supply outlet 124 to the feeding container 140 below the food supply outlet 124 for animals to enjoy. The driving mechanism 170 is in communicatively connection with the controller 150, and the controller 150 sends a control signal to the driving mechanism 170 according to parameters set by a user, so that the driving mechanism 170 drives the quantitative supply mechanism 160 to quantitatively guide food in a manner set by the user.

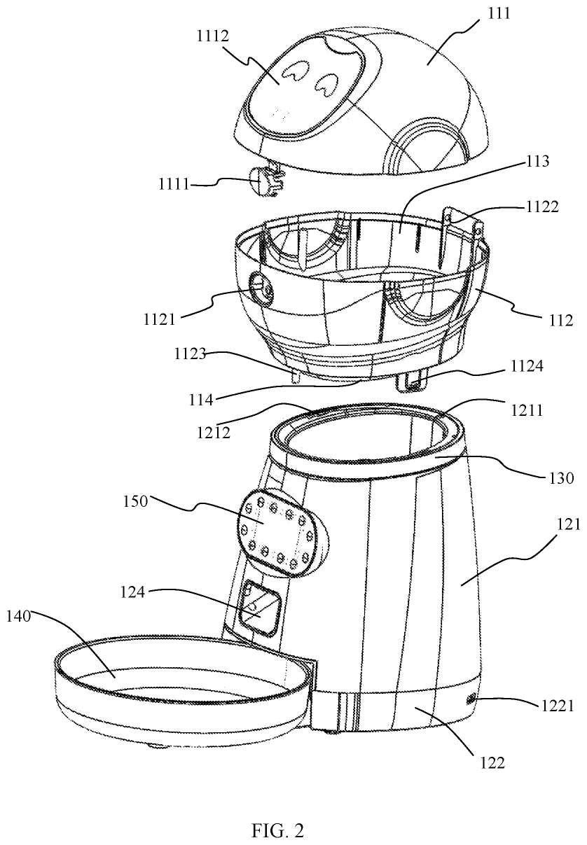

As shown in FIG. 2 for details, the food storage container 110 comprises a food storage cover 111 and a food storage barrel 112. A top of the food storage barrel 112 is open to form a material inlet 113, and a bottom of the food storage barrel 112 is open to form a material outlet 114. The food storage cover 111 is closed on the top of the food storage barrel 112 to close the material inlet 113. When the food storage cover 111 is opened, food can be added into the food storage barrel 112. As further shown in FIG. 2, a pivot seat 1122 is provided at a rear side of the top of the food storage barrel 112, and a pivot shaft (not visible in the figure) is correspondingly provided at a rear side of the bottom of the food storage cover 111, which is pivotally connected to the pivot seat 1112, so that the food storage cover 111 can be rotationally opened and closed relative to the food storage barrel 112. Moreover, an elastic button 1111 which extends downwards is provided at a front side of the bottom of the food storage cover 111, and a corresponding hole 1121 is provided at a front side of the food storage barrel 112. The elastic button 1111 can be placed in the hole 1121 to limit the food storage cover 111 being closed on the food storage barrel 112. When the elastic button 1111 is pushed inward through the hole 1121 to get rid of the restriction of the hole 1121, the food storage cover 111 can be opened. Further, after the food storage cover 111 and the food storage barrel 112 are closed, they can form a spherical shape as shown in FIG. 1. Setting the front side of the food storage cover 111 as a decoration part 1112 similar to a face of a robot can increase interest of the entire automatic feeding device for animals 100. The decoration part 1112 can also be designed as a transparent or semi-transparent part, which is convenient for the user to check a food remaining amount inside the food storage container 110. Further referring to FIGS. 1 and 2, the food storage container 110 is detachably plugged into a top of the food supply container 120, and a decorative ring 130 can be placed at the junction of the two containers to increase the beauty of the entire device. According to different specific embodiments of the present application, the upper food storage container 110 and the lower food supply container 120 can also be connected through the decorative ring 130. Specifically, as shown in FIG. 2, the bottom of the food storage barrel 112 is provided with a positioning post 1123 and a buckle 1124 extending downward along a circumferential direction. A positioning hole 1211 and a slot 1212 cooperating with the positioning post 1123 and the buckle 1124 are formed on a top of a food supply barrel 121 of the food supply container 120 along its circumferential direction. With a cooperation of these components, the food storage barrel 112 is inserted into the top of the food supply barrel 121, and when the food storage barrel 112 is pulled upwards with a slight force, the buckle 1124 can get rid of a limitation of the slot 1212, so that the food storage barrel 112 can be removed from the food supply barrel 121, which is convenient for cleaning and maintenance.

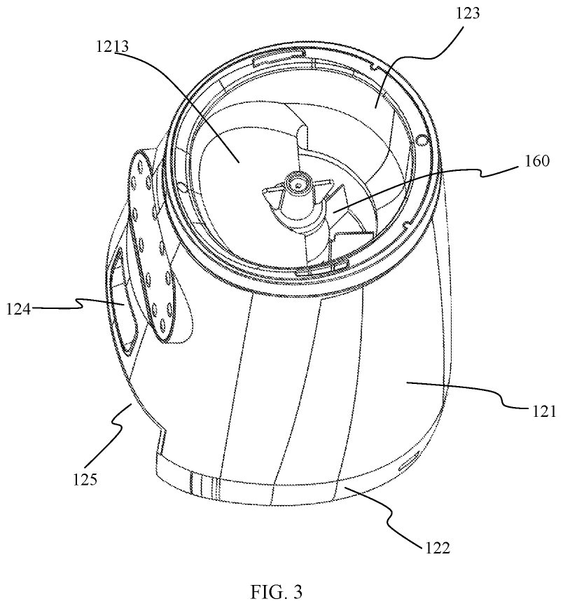

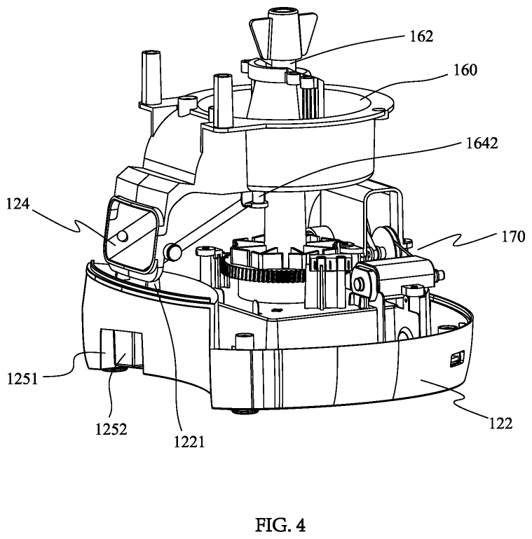

Referring again to FIGS. 2 and 3, the food supply container 120 comprises a food supply barrel 121 and a base 122. A top of the food supply barrel 121 is open to form a food supply inlet 123 which is in butt joint with the material outlet 114 of the food storage container 110. The quantitative supply mechanism 160 is provided in the food supply barrel 121, and driven by the driving mechanism 170 provided in the base 122. By the quantitative supply mechanism 160, the food that enters the food supply barrel 121 from the food supply inlet 123 is led out to the food supply outlet 124 provided on a lower front side of the food supply barrel 121. A front side of the base 122 is concavely formed with a notch 125 for placing the feeding container 140. The food falls into the feeding container 140 below from the food supply outlet 124 by its own gravity, and can be enjoyed by the animals. Referring to FIGS. 4 and 7 specifically, the concaved front side of the base 122 is provided with two installation grooves 1251 and a limiting post 1252 extends downward in each of the installation grooves 1251. The feeding container 140 has a basin body 141, and two mounting blocks 142 are correspondingly provided on an outer side of the basin body 141, and a limiting hole 143 is formed in each of the mounting blocks 143. By placing the mounting blocks 142 in the mounting grooves 1251 and inserting the limiting post 1252 into the limiting hole 143, the feeding container 140 can be positioned and placed in the notch 125 of the base 122.

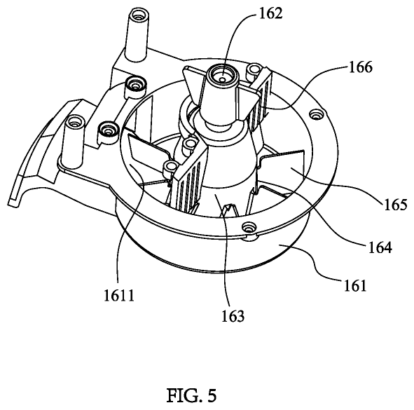

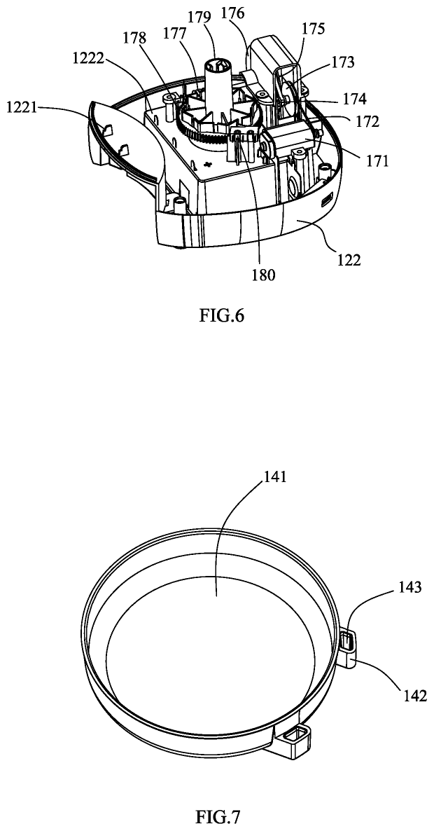

Referring again to FIGS. 4 and 5, the quantitative supply mechanism 160 comprises a supply bowl 161, a supply shaft 162, a supply wheel 163, supply plates 165 and a supply comb 166. The supply bowl 161 can be fixedly installed under the food supply inlet 123 in the food supply barrel 121 through various existing suitable positioning and fixing structures. The supply shaft 162 is vertically installed in the center of the supply bowl 161 and passes through a bottom of the supply bowl 161. The supply wheel 163 is fixed on the supply shaft 162 in the supply bowl 161 to rotate with the supply shaft 162. The supply wheel 163 is provided with a plurality of installation grooves 164 at intervals around its circumference, and a plurality of supply plates 165 are installed in conjunction with the installation grooves 164, and the plurality of supply plates 165 rotate together with the supply shaft 162 in the supply bowl 161. A quantitative supply space is formed between every two adjacent supply plates 165. Moreover, a through cut 1611 is formed at the bottom and side wall of the supply bowl 161 close to the food supply outlet 124, and the through cut 1611 is in butt joint with the food supply outlet 124. When pet food falls from the food supply inlet 123 into a quantitative supply space between two adjacent supply plates 165 in the supply bowl 161, the pet food is led out to the through cut 1611 as the supply shaft 162 drives the supply plates 165 to rotate, and falls into the food supply outlet 124 through the through cut 1611, and then the pet food falls into the feeding container 140 from the food supply outlet 124. By controlling a rotation angle of the supply shaft 162 driven by the driving mechanism 170 under control of the controller 150, only food in one quantitative supply space can be exported at a time, and quantitative feeding can be realized. Moreover, by adjusting the spacing between the plurality of supply plates 165, the size of the quantitative supply space can be changed, thereby changing a single feeding amount. Again referring to FIG. 3, an inclined guide plate 1213 is positioned over the quantitative supply mechanism 160 in the food supply barrel 121 at the side facing the through cut 1611. The guide plate 1213 can just guide food falling from the food supply inlet 123 into each quantitative supply spaces at the side of the supply bowl 161 away from the through cut 1611, which prevents the food from falling directly from the through cut 1611, and facilitates the accumulation of food downward. In addition, as shown in FIG. 5, a supply comb 166 is fixed in the supply bowl 161 facing a lower end of the guide plate 1213, and the supply comb 166 is located above the supply plate 165 to guide the food as much as possible to the quantitative supply spaces between the supply plates 165. Referring again to FIGS. 4 and 6, the food supply outlet 124 is arranged obliquely below the through cut 1611 of the supply bowl 161, and the food falling from the through cut 1611 is guided out through the food supply outlet 124 by the weight of the food itself. A lower end of the food supply outlet 124 is directly supported on two supporting steps 1221 (see FIG. 6) provided above the notch 125 of the base 122, and an upper end of the food supply outlet 124, which is in butt joint with the through cut 1611, is installed on installation positioning posts 1642 extending downwards from the bottom of the supply bowl 161. Thus the food supply outlet 124 is independently detachable, which is convenient for cleaning and maintenance.

Further referring to FIG. 6, the driving mechanism 170 comprises a driving motor 171, a first transmission belt 172, a first transmission wheel 173, a second transmission wheel 174, a second transmission belt 175, a third transmission wheel 176, a worm 177, and a gear plate 178. A mounting platform 1222 is protruding from the middle of the base 122. The worm 177 and the gear plate 178 are supported on the mounting platform 1222. The drive motor 171, the first transmission wheel 173, the second transmission wheel 174, and the third transmission wheel 176 are also installed at a height as similar as the gear plate 178 by corresponding support structures extending upwards in the base 122, so that the structure of the entire driving mechanism 170 is relatively compact, which effectively reduces the occupied space. A power module such as a battery that is electrically connected to the controller 150 can be arranged in a space of the base 122 under the installation platform 1222 to make full use of the space, and an external power source can be connected through a connection interface, such as a USB interface 1221, provided on the rear side of the base 122. The driving motor 171 operates based on the control signal of the controller 150. An output end of the driving motor 171 drives the first transmission wheel 173 to rotate through the first transmission belt 172, thereby driving the second transmission wheel 174 coaxial with the first transmission wheel 173 to rotate, and then driving the third transmission wheel 176 to rotate by the second transmission belt 17, thereby driving the worm 177 coaxial with the second transmission wheel 176 to rotate, thereby driving the gear plate 178 meshed with the worm 177 to rotate. The gear plate 178 is provided with a coupling structure 179 that is coaxially connected with the supply shaft 162 of the quantitative supply mechanism 160 to drive the supply shaft 162 to rotate. As further shown in FIG. 6, a sensory switch 180 is also provided on the installation platform 1222 for monitoring the rotation angle of the gear plate 178 and feed it back to the controller 150. Referring to FIGS. 1 and 2 again, the controller 150 is installed on the front side of the supply barrel 121 above the food supply outlet 124, and is used for sending the control signal to the driving motor 171 according to the parameters set by the user (such as pet type, feeding time and feeding amount, etc.). The controller 150 can be implemented by various existing suitable technical means. For example, the controller 150 can be provided with a control circuit board and provided with a display screen and/or control buttons for the user to set. This is the prior art, therefore it will not be detailedly described in the present application.

The automatic feeding device for animals 100 according to the above-mentioned first embodiment of the present application can open the food storage cover 111 to add food, and then the food falls into the food supply inlet 123 of the food supply container 120 through the material outlet 114, and falls into the quantitative supply space between adjacent supply plates 165 in the supply bowl 161 by the function of the guide plate 1213. The controller 150 controls the driving motor 171 to rotate according to the user's setting, and can drive the supply shaft 162 to rotate a certain angle to lead the food in the quantitative feeding space to the food supply outlet 124 and then falls into the feeding container 140.

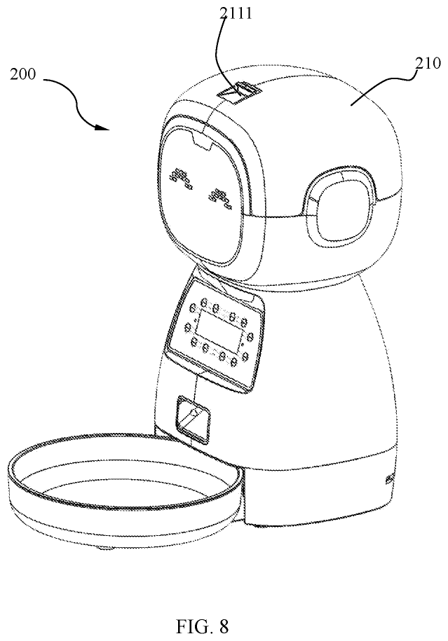

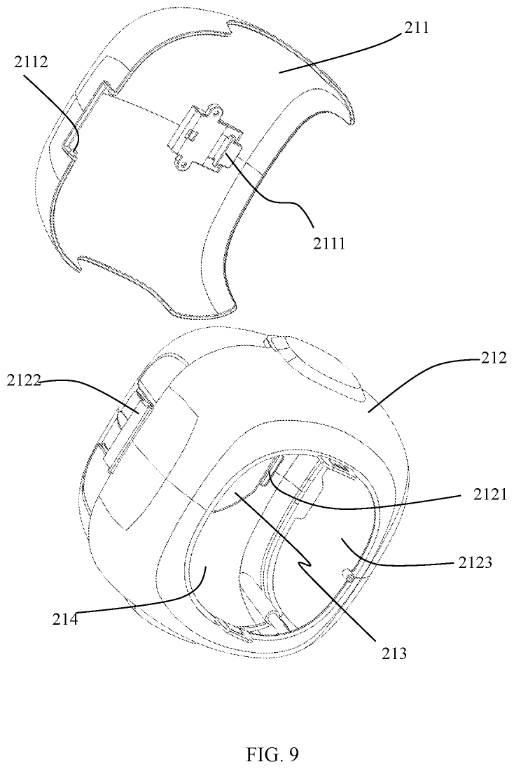

FIG. 8 and FIG. 9 show schematic structural diagrams of an automatic feeding device for animals 200 according to a second embodiment of the present application. As shown in FIGS. 8 and 9, the automatic feeding device for animals 200 according to the second embodiment of the present application has basically the same structure as the automatic feeding device for animals 100 according to the first embodiment, with the main difference being a specific structure of a food storage container 210 of the automatic feeding device for animals 200 is slightly different from that of the food storage container 110 of the automatic feeding device for animals 100. As shown in FIG. 9 specifically, the food storage container 210 comprises a food storage cover 211 and a food storage barrel 212. A top of the food storage barrel 212 is open to form a material inlet 213, and a bottom of the food storage barrel 212 is open to form a material outlet 214. The food storage cover 211 is closed on the top of the food storage barrel 212 to close the material inlet 213. When the food storage cover 211 is opened, food can be added into the food storage barrel 212. Similarly, the food storage cover 211 and the food storage barrel 212 are pivotally connected at the rear side through a pivot seat 2122 and a pivot shaft 2112 cooperated with each other, so that the food storage cover 211 can be rotatably opened and closed relative to the food storage barrel 212. However, the opening and closing manner of the food storage cover 211 relative to the food storage barrel 212 is different from the food storage container 110 of the first embodiment. Referring to FIGS. 8 and 9, a slot 2121 is formed on the inner wall of the front side of the food storage barrel 212 at the material inlet 213, and a movable elastic latch 2111 at a corresponding position on the top of the food storage cover 211 is inserted into the slot 2121, thus the food storage cover 211 is closed on the food storage barrel 212. When the user pushes the elastic latch 2111 backward to disengage the food storage cover 211 from the slot 2121, the food storage cover 211 can be opened. In addition, a transparent or translucent decorative member 2123 is provided on the front side of the food storage barrel 212, so that the user can check the food remaining amount inside the food storage barrel 212.

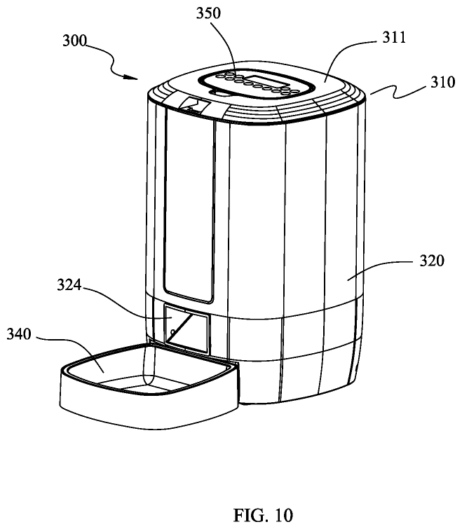

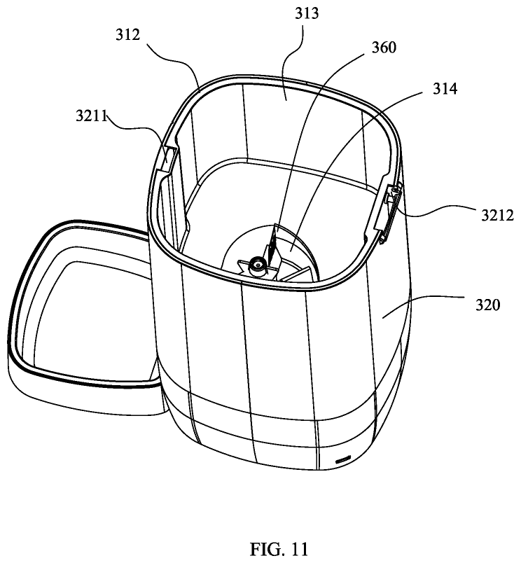

FIGS. 10 to 12 show schematic structural diagrams of an automatic feeding device for animals 300 according to a third embodiment of the present application. As shown in FIGS. 10 to 12, the structural principle of the automatic feeding device for animals 300 according to the third embodiment of the present application is basically the same as that of the automatic feeding device for animals 100 according to the first embodiment. The automatic feeding device for animals 300 also comprises a food storage container 320, a food supply container 340, a quantitative supply mechanism 360, a driving mechanism 370, and a controller 350. The difference is that the specific implementation of the food storage container 310 of the automatic feeding device for animals 300 is different from the food storage container 110 of the automatic feeding device for animals 100. Referring to FIGS. 10 to 12, the food storage container 310 comprises a food storage cover 311 and a food storage barrel 312, and the food storage barrel 312 is accommodated in the food supply container 320 above the quantitative supply mechanism 360. A material outlet 314 at the bottom of the food storage barrel 312 is directly connected to the quantitative supply mechanism 360. Food enters from a material inlet 313 formed at the top of the food storage barrel 321, and falls into the quantitative supply mechanism 360 from the material outlet 314, and then is quantitatively exported to a food supply outlet 324 provided on the front side of the food supply container 320 and then falls into the feeding container 340. Since the food storage barrel 312 is designed to be housed in the food supply container 320, the food storage cover 311 is directly closed on the top of the food supply container 320. A rear side of the food storage cover 311 is pivotally connected to the food supply container 320 through matching pivot structures 3112 and 3212, and a front side of the food storage cover 311 is movably connected to the food supply container 320 through a matching movable buckle structure 3211, so that it can be opened and closed relative to the food supply container 320.

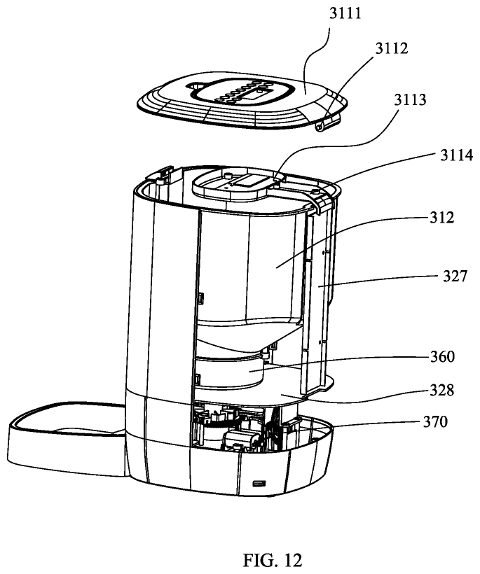

In this embodiment, the controller 350 is arranged on the top of the food storage cover 311 and is electrically connected to the driving mechanism 370 to control the driving mechanism 370 to drive the quantitative supply mechanism 360 to work according to the setting of the user. As shown in FIG. 12 for details, the food storage cover 311 further comprises a cover body 3111 and a control box 3113. A rear side of the cover body 3111 is pivotally connected to the food supply container 320 through a matching pivot structure, and a front side is movably connected to the food supply container 320 through a matching movable buckle structure. The control box 3113 is installed in the middle of the bottom of the cover body 3111 for installing and fixing the controller 350, and a first wire groove 3114 extends laterally rearwards out of the rear side of the control box 3113, and the first wire groove 3114 is bent downwards at a pivoting position of the cover body 3111 and the food supply container 320 so as to be inserted into a second wire groove 327 vertically arranged along an inner wall of the food supply container 320. in this way, wires electrically connected between the controller 350 and the driving mechanism 370 can be led out from the control box 3113, and then enter the second wire groove 327 through the pivoting position of the food storage cover 311 and the food supply container 320 through the first wire groove 3114, and then go downward along the second guide groove 327, and finally is introduced into the bottom of the food supply container 320 to be electrically connected to the driving mechanism 370. As further shown in FIG. 12, an isolation plate 328 is provided between the quantitative supply mechanism 360 and the driving mechanism 370 in the food supply container 320 to isolate components of the driving mechanism 370 at the bottom of the food supply container 320.

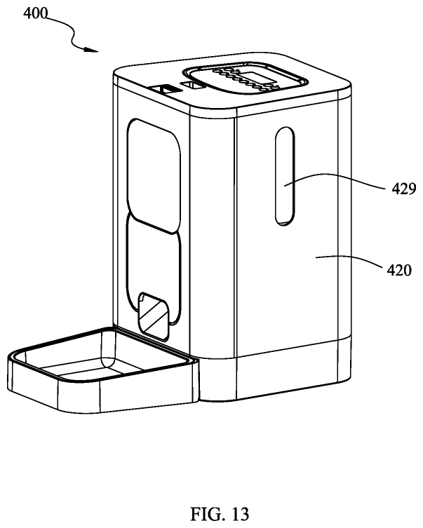

FIG. 13 shows a schematic structural diagram of an automatic feeding device for animals 400 according to a fourth embodiment of the present application. As shown in FIG. 13, the automatic feeding device for animals 400 according to the fourth embodiment of the present application has basically the same structure as the automatic feeding device for animals 300 according to the third embodiment. Moreover, the automatic feeding device for animals 400 is also provided with an observation window 429 on a side wall of its food supply container 420. The observation window 429 can be designed as a transparent or semi-transparent member, so that the user can check the food remaining amount.

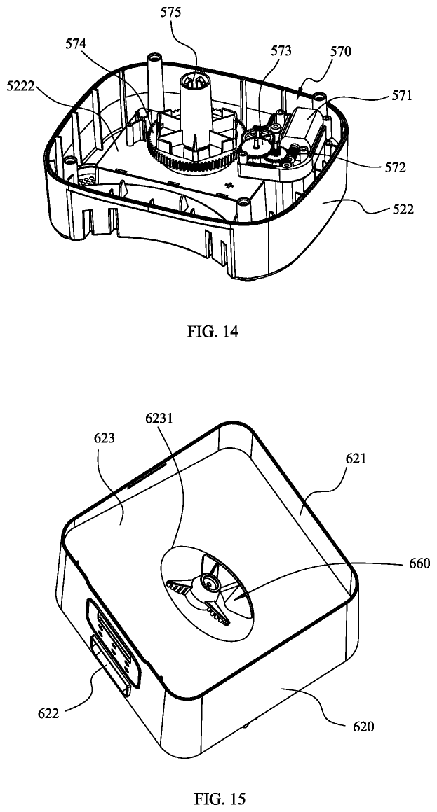

FIG. 14 shows a schematic structural diagram of a base 522 and a driving mechanism 570 according to a fifth embodiment of the present application. Different from a transmission mode of the driving mechanism 170 described in conjunction with FIG. 6 in the foregoing first embodiment, the driving mechanism 570 adopts gear transmission. Specifically, as shown in FIG. 14, the driving mechanism 570 is arranged in the base 522, and comprises a driving motor 571, a worm 572, a transmission gear set 573, an output gear 574 and a coupling structure 575. A mounting platform 5222 is protruding from the middle of the base 522, and the output gear 574 is rotatably supported on the mounting platform 5222. The drive motor 571, the worm 572, and the transmission gear set 573 are also installed at a height as similar as the output gear 574 by corresponding support structures provided in the base 522, so that the structure of the entire driving mechanism 570 is relatively compact. A power module such as a battery can be arranged in a space of the base 122 under the installation platform 1222 to make full use of the space. The driving motor 571 operates based on control signal of a controller. An output end of the driving motor 571 is connected to the worm 572, and the output gear 574 is driven to rotate through the transmission gear set 573 which is engaged with the worm 572. The output gear 574 is provided with the coupling structure 575 which is coaxially connected with a supply shaft of a quantitative supply mechanism to drive the supply shaft to rotate.

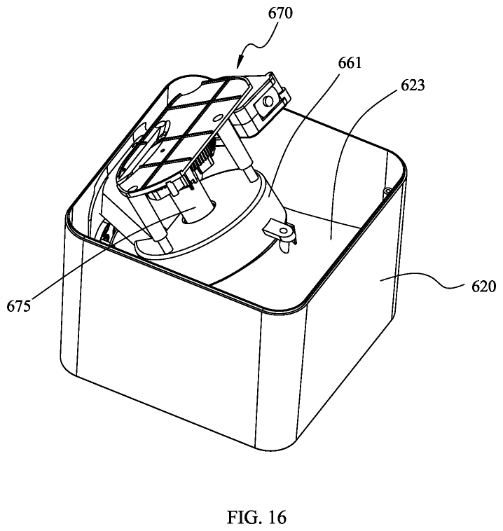

FIG. 15 and FIG. 16 respectively show schematic structural diagram of a food supply container 620 and the quantitative supply mechanism 660 and the driving mechanism 670 arranged in the food supply container 620 according to a sixth embodiment of the present application from different perspectives. Different from the foregoing embodiments, the quantitative supply mechanism 660 and the drive mechanism 670 are installed in the food supply container 620 inclined with respect to a horizontal direction. The structure of the quantitative supply mechanism 660 is basically the same as that of the quantitative supply mechanism 160 in the first embodiment described in conjunction with FIG. 5, but is installed in the food container 620 in an inclined state. The structure of the driving mechanism 670 is basically the same as the driving mechanism 570 in the fifth embodiment described in conjunction with FIG. 14, but is installed at the bottom of the food supply container 620 in an inclined state. A coupling structure 675 of the driving mechanism 670 is obliquely extended, and drives a supply shaft (not visible in the figures) in a supply bowl 661 that is arranged obliquely to rotate. Further referring to FIGS. 15 and 16, a guide plate 623 is provided in the food supply container 620 above the quantitative supply mechanism 660. The guide plate 623 has a guide hole 6231 facing the quantitative feeding mechanism 660. The guide plate 623 is tilted and gathered from its periphery to the guide hole 6231 to facilitate the gathering of food downward. Food falling from a food supply inlet 621 of the food supply container 620 falls into a quantitative supply space of the supply bowl 661 of the quantitative supply mechanism 660 through the guide hole 6231 of the guide plate 623, and then quantitatively falls out from a food supply outlet 622.

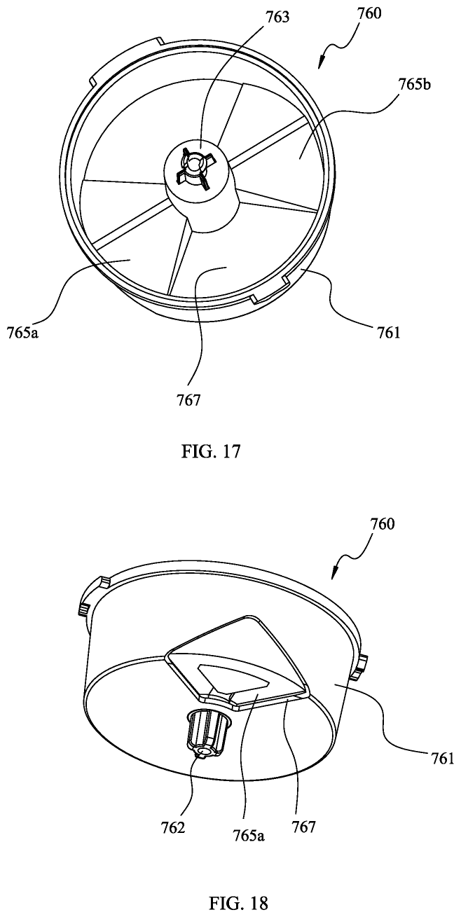

FIG. 17 and FIG. 18 respectively show schematic structural diagrams of a quantitative supply mechanism 760 according to a seventh embodiment of the present application from different perspectives. Referring to FIG. 17 and FIG. 18, the quantitative supply mechanism 760 comprises a supply bowl 761, a supply shaft 762, a supply wheel 763, and supply blocks 765a, 765b. The quantitative supply mechanism 760 has a similar structure as that of the quantitative supply mechanism 160 in the first embodiment described in conjunction with FIG. 5, except that the supply blocks 765a and 765b are used instead of the multiple supply plates 165. In the quantitative supply mechanism 760 according to the seventh embodiment of the present application, the supply bowl 761 can also be fixedly installed under a food supply inlet in a food supply container through various existing suitable positioning and fixing structures. The supply shaft 762 is installed in the center of the supply bowl 761 and passes through a bottom of the supply bowl 761. The supply wheel 763 is fixed on the supply shaft 762 in the supply bowl 761 so as to rotate with the supply shaft 762. The supply wheel 763 is provided with two supply blocks 765a, 765b at intervals around its circumference. The two supply blocks 765a, 765b rotate together with the supply shaft 762 in the supply bowl 761. Two quantitative supply spaces are formed between the two supply blocks 765a, 765b. Moreover, a through cut 767 is formed at the bottom and side wall of the supply bowl 761 close to a food supply outlet of the food supply container, and the through cut 767 is in butt joint with the food supply outlet. When pet food falls into the quantitative feeding space in the supply bowl 761, the pet food is led out to the through cut 767 as the supply shaft 762 drives the supply blocks 765a, 765b to rotate, and falls out through the through cut 767. By controlling a rotation angle of the supply shaft 762, only food in one quantitative supply space can be exported at a time, and quantitative feeding can be realized. Moreover, the supply blocks 765a, 765b in this embodiment are designed to have a shape that can cover the through cut 767. When the supply blocks 765a, 765b are driven to rotate by the supply shaft 762 to lead the quantitative food out of the through cut 767, continued rotation of the supply blocks 765a, 765b enable one of the blocks 765a, 765b cover the through cut 767. Advantages of this design is that on one hand, it can prevent food from accidentally falling out of the through cut 767, on the other hand, it can protect the food in the food supply container to a certain extent, such as preventing insects from entering and contaminating the food through the through cut 767.

The above are only the preferred embodiments of the present application and are not intended to limit the present application. Any modification, equivalent replacement and improvement made within the spirit and principle of the present application shall be included in the range of protection of the present application.

1. An automatic feeding device for animals, comprising a food storage container, a food supply container, a feeding container, a quantitative supply mechanism, a driving mechanism and a controller, wherein the food storage container has a material inlet and a material outlet, the food supply container has a food supply inlet and a food supply outlet, and the food supply inlet of the food supply container is in butt joint with the material outlet of the food storage container, the quantitative supply mechanism is provided between the food supply inlet and the food supply outlet in the food supply container, the driving mechanism is provided below the quantitative supply mechanism in the food supply container, the feeding container is provided outside the food supply container below the food supply outlet, and the controller sends a control signal to the driving mechanism which controls the driving mechanism to drive the quantitative supply mechanism to quantitatively export food entering the food supply container from the food storage container to the food supply outlet, from which the food falls into the feeding container.

2. The automatic feeding device for animals according to claim 1, wherein the food storage container comprises a food storage cover and a food storage barrel, and a top of the food storage barrel is open to form a material inlet, a bottom of the food storage barrel is open to form a material outlet, and the food storage cover is closed on the top of the food storage barrel to close the material inlet, and detachable positioning and inserting structures are provided at the bottom of the food storage barrel along its circumferential direction that cooperates with a top of the food supply container.

3. The automatic feeding device for animals according to claim 2, wherein a rear side of the food storage cover is pivotally connected to the food storage barrel, and a front side of the food storage cover is provided with a downwardly extending elastic button which cooperates with a corresponding hole on a front side of the food storage barrel to realize a detachable buckling connection.

4. The automatic feeding device for animals according to claim 2, wherein a rear side of the food storage cover is pivotally connected to the food storage barrel, and a slot is provided on inner wall of the front side of the food storage barrel at the material inlet, and a movable elastic latch at a corresponding position on the top of the food storage cover is inserted into the slot so that the food storage cover is closed on the food storage barrel.

5. The automatic feeding device for animals according to claim 2, wherein a transparent or translucent decorative part is further provided on the front side of the food storage cover or the food storage barrel.

6. The automatic feeding device for animals according to claim 1, wherein the food storage container comprises a food storage cover and a food storage barrel, and the food storage barrel is accommodated in the food supply container above the quantitative supply mechanism, a material outlet at the bottom of the food storage barrel serves as a food supply inlet of the food supply container to be directly in butt joint with the quantitative supply mechanism, the food storage cover is closed on the top of the food supply container, and a rear side of the food storage cover is pivotally connected with the food supply container, and a front side of the food storage cover is detachably buckled with the food supply container.

7. The automatic feeding device for animals according to claim 6, wherein the food storage cover comprises a cover body and a control box installed at the bottom of the cover body, and a rear side of the cover body is pivotally connected to the food supply container, a front side of the cover body is detachably buckled with the food supply container, and the control box is provided with a first wire groove extending backward to a pivoting position of the cover body and the food supply container and docked with a second wire groove vertically arranged in the food supply container; the controller is installed and fixed in the control box, and wires of the controller are led out from the control box, and then enter from the first wire groove through the pivoting position of the food storage cover and the food supply container into the second wire groove, thus are electrically connected with the driving mechanism.

8. The automatic feeding device for animals according to claim 6, wherein a transparent or translucent observation window is provided on a side wall of the food supply container.

9. The automatic feeding device for animals according to claim 1, wherein the quantitative supply mechanism comprises a supply bowl, a supply shaft, a supply wheel and a plurality of supply plates, and the supply bowl is fixed in the food supply container below the food supply inlet, the supply shaft is vertically installed in the center of the supply bowl and passes through the bottom of the supply bowl, the supply wheel is fixed on the supply shaft in the supply bowl, and the plurality of supply plates are installed on the supply wheel at intervals around its circumference to rotate in the supply bowl along with the supply shaft, and a quantitative feeding space is formed between every two adjacent supply plates, and a through cut is formed on the side of the supply bowl close to the food supply outlet to be in butt joint with the food supply outlet.

10. The automatic feeding device for animals according to claim 9, wherein an inclined guide plate is positioned over the quantitative supply mechanism in the food supply container at the side facing the through cut, and the guide plate guides food to the side of the supply bowl away from the through cut.

11. The automatic feeding device for animals according to claim 10, wherein a supply comb is fixed in the supply bowl above the supply plates and the supply comb is located directly facing a lower end of the guide plate.

12. The automatic feeding device for animals according to claim 9, wherein the food supply outlet is obliquely arranged below the through cut of the supply bowl, and a lower end of the food supply outlet is supported on corresponding supporting steps provided in the food supply container, and an upper end of the food supply outlet is installed at the bottom of the supply bowl.

13. The automatic feeding device for animals according to claim 9, wherein the driving mechanism comprises a driving motor, a first transmission belt, a first transmission wheel, a second transmission wheel, a second transmission belt, a third transmission wheel, a worm and gear plate; the driving motor is electrically connected to the controller, and an output end of the driving motor drives the first transmission wheel to rotate through the first transmission belt, thereby driving the second transmission wheel coaxial with the first transmission wheel to rotate, and then driving the third transmission wheel to rotate by the second transmission belt, thereby driving the worm coaxial with the second transmission wheel to rotate, thereby driving the gear plate meshed with the worm to rotate; and the gear plate is provided with a coupling structure that is coaxially connected with the supply shaft.

14. The automatic feeding device for animals according to claim 13, wherein the driving mechanism further comprises a sensory switch which monitors a rotation angle of the gear plate and feeds it back to the controller.

15. The automatic feeding device for animals according to claim 1, wherein a base below the food supply outlet of the food supply container is concavely formed with a notch, and the feeding container is installed in the notch through a limiting structure.

16. The automatic feeding device for animals according to claim 1, wherein the quantitative supply mechanism comprises a supply bowl, a supply shaft, a supply wheel and at least two supply blocks, and the supply bowl is fixed in the food supply container below the food supply inlet, the supply shaft is installed in the center of the supply bowl and passes through the bottom of the supply bowl, the supply wheel is fixed on the supply shaft in the supply bowl, and the at least two supply blocks are installed on the supply wheel at intervals around its circumference to rotate in the supply bowl along with the supply shaft, and a quantitative feeding space is formed between every two adjacent supply plates, and a through cut is formed on the side of the supply bowl close to the food supply outlet to be in butt joint with the food supply outlet, and the at least two supply blocks have a shape that can cover the through cut.

17. The automatic feeding device for animals according to claim 1, wherein the driving mechanism comprises a driving motor, a worm, a transmission gear set and an output gear; the driving motor is electrically connected to the controller, and an output end of the driving motor drives the transmission gear set to rotate through the worm, thereby driving the output gear to rotate through the transmission gear set; and the output gear is provided with a coupling structure that is coaxially connected with a supply shaft of the quantitative supply mechanism.

18. The automatic feeding device for animals according to claim 1, wherein the quantitative supply mechanism and the driving mechanism are installed in the food supply container obliquely with respect to a horizontal direction.
